(19) United States
(12) Patent Application Publication
(10) Pub. No.: US 2015/0363058 A1
(43) Pub. Date: Dec. 17, 2015

(54) METHOD AND APPARATUS FOR DISPLAYING DATA ON BASIS OF ELECTRONIC MEDICAL RECORD SYSTEM

(71) Applicant: SEOUL NATIONAL UNIVERSITY BUNDANG HOSPITAL, Seongnam-si, Gyeonggi-do (KR)

(72) Inventors: Chin Youb CHUNG, Gyeonggi-do (KR); Rong Min BAEK, Gyeonggi-do (KR); Hee HWANG, Daejeon (KR); Kee Hyuck LEE, Gyeonggi-do (KR); Soo Young YOO, Gyeonggi-do (KR); Jong Hoar YOON, Gyeonggi-do (KR); Eun Young CHO, Gyeonggi-do (KR); Hyun Young BAEK, Gyeonggi-do (US)

(21) Appl. No.: 14/763,168

(22) PCT Filed: Jan. 17, 2014
(86) PCT No.: PCT/KR2014/000499

§ 371 Date: Jul. 24, 2015

(30) Foreign Application Priority Data
Jan. 24, 2013 (KR) 10-2013-0007892

(51) Int. Cl. G06F 3/0482; G06F 17/30; G06F 3/0484; G06T 11/60; G06F 19/00

(52) U.S. Cl. CPC G06F 3/0482; G06T 11/60; G06F 19/322; G06F 3/04842; G06F 17/30572; G06F 3/04847; G06T 2210/41

(57) ABSTRACT

A method for displaying data on the basis of an electronic medical record system, includes the steps of: displaying, on a screen, an item list within a specific service function which has a plurality of separate regions and in which items corresponding to the separate regions are formed; displaying a screen on which time-series information is visualized in response to a specific item screen request signal selected from the displayed list; storing and displaying an event generated according to each of predetermined time-series information types on the screen on which the time-series information is visualized, according to a time course of a predetermined axis perpendicular to the axis on which the time-series information types are displayed; activating a partial region selected according to a user input in an entire region of the screen on which the event is displayed, and controlling the activated partial region according to the state of the user input.

### TECHNICAL FIELD

The present invention relates, in general, to a method and apparatus for displaying data based on electronic medical records, and more particularly, to a data display technique whereby time-series information is visualized in order to enable access to information in a single screen without frequent movement between screens for searching for various pieces of information on a specific patient.

### BACKGROUND ART

Generally, the combination of paper chart-based medical records with IT technology to computerize all pieces of medical information generated in hospitals without any change is called an electronic medical record (EMR) type. This EMR type refers to a type for recording, in a certain database, all types of medical information generated while treating a patient, for example, physical condition, medical history, test results, prescription results, drug responses, and hospitalization/discharge records of the patient.

The EMR type is desirable in view of improving the competitiveness of a hospital, improving the medical environment, and securing clinical research data. In other words, according to the construction of an automated system, information on hospital management may be obtained, human resources may be efficiently used, a personal medical history may be traced to provide customized medical service, and clinical data may be accumulated for use in various fields. In addition, it is effective in improving work efficiency, enhancing communication among medical staff, and preventing medical malpractice.

However, when trying to obtain a patient's information using this EMR system, a medical worker checks various pieces of information such as basic information, vital signs, input/output data, and record sheets for progress after hospitalization through a main screen on the EMR, and then in order to check additional test results, has to move to a main screen of each medical treatment support part and input a patient's number to access information on the patient. In other words, in order for the medical worker to search for desired information, he or she has to move between various screens, and accordingly a large number of manipulations is necessary. In addition, in the case of a hospital where the EMR is not implemented, it may be impossible for the medical worker to check all data in one screen.

### DISCLOSURE

### Technical Problem

Accordingly, the present invention has been made keeping in mind the above problems occurring in the prior art, and an object of the present invention is to provide a method and apparatus for displaying data based on an electronic medical record, which are capable of storing and displaying events for individual types of time-series information, preset to enable a patient's event data to be viewed in a single view and to be edited in a single screen with the lapse of time on an axis on which the time-series information type is shown and a predetermined axis, perpendicular to that axis, by providing sequentially visualized and integrated data on the basis of previously stored information on individual patients provided from the EMR system.

### Technical Solution

In order to accomplish the above object, the present invention provides a method for displaying data based on an electronic medical record (EMR) system. The method includes: displaying, on a screen, an item list of a specific service function, wherein the item list has a plurality of partitioned areas and an item corresponding to each of the plurality of partitioned areas is formed; displaying a screen in which time-series information is visualized in response to a request signal for a specific item screen selected from the displayed list; storing and displaying an event occurring for a preset time-series information type on the screen in which the time-series information is visualized with a lapse of time on a predetermined axis, which is perpendicular to an axis on which the time-series information type is shown; and activating a partial area, selected by a user input from among the entire screen area, in which the event is displayed, and controlling the activated partial area according to the user input state.

In order to accomplish the above object, the present invention provides an apparatus for displaying data based on an EMR system. The apparatus includes: a time-series information providing unit storing time-series information for an object; a user's query processing unit receiving a desired type of time-series information and the display state of the time-series information from a user; and a controller displaying, on a screen, an item list in a specific service function, wherein the item list has a plurality of partitioned areas and an item corresponding to each of the plurality of partitioned areas is formed; displaying a screen in which time-series information is visualized in response to a request signal for a screen of a specific item selected from the displayed list; storing and displaying an event occurring for a preset time-series information type on the screen in which the time-series information is visualized with a lapse of time on a predetermined axis, which is perpendicular to an axis on which the time-series information type is shown; and activating a partial area selected by a user input in an entire screen area in which the event is displayed and controlling the activated partial area according to the user input state.

### Advantageous Effects

According to the present invention, a medical worker may more rapidly and conveniently access information for each patient in a single screen without frequent movement between screens in order to obtain patient's information existing in various formats, and a corresponding screen is dynamically editable, and accordingly various pieces of information with the lapse of time or for an event type are intuitively recognizable by providing various editing and display functions according to the user input state in the single screen in which the time-series information is visualized, and additionally, continuous tracking and observation of the patient are enabled.

### DESCRIPTION OF DRAWINGS

FIG. 1 is an overall flowchart for a method of displaying data based on an electronic medical record system according to an embodiment of the present invention;

FIG. 2 is an exemplary screen to which a method of displaying data based on an electronic medical record system according to an embodiment of the present invention is applied;

FIG. 3 is an exemplary overall screen to which a method of displaying data based on an electronic medical record system according to an embodiment of the present invention is applied;

FIG. 4 is an exemplary detailed overall screen to which a method of displaying data based on an electronic medical record system according to an embodiment of the present invention is applied; and

FIG. 5 is a detailed block diagram for an apparatus for displaying data based on an electronic medical record system according to an embodiment of the present invention.

### BEST MODE

Reference should now be made to the drawings, in which the same reference numerals are used throughout the different drawings to designate the same or similar components.

Hereinafter, embodiments of the present invention will be described in detail with reference to the accompanying drawings. While details such as specific components are given in the following description, it is to be clearly understood to those skilled in the art that the details are provided to assist comprehensive understanding of the present invention and thus many modifications and changes can be made within the scope and spirit of the present invention.

The present invention relates to a data display in an (electronic medical record EMR) system, and particularly, to a technique for storing and displaying an event for each type of time-series information, preset to enable a patient's event data to be viewed in a single view and edited in a single screen according to time changes on the axis on which the time-series information type is shown and a predetermined axis, perpendicular to that axis, by providing sequentially visualized and integrated data on the basis of a patient's previously stored information provided from the EMR system, for activating a partial area, selected by user input, from among the entire screen that displays the event, for enabling a medical worker to more rapidly and conveniently access the patient's information in a single screen without frequent movement between screens in order to obtain the patient's information, existing in various forms, by controlling the activated partial area according to the user input state, and for enabling a corresponding screen to be dynamically editable and accordingly enabling various pieces of information for a time change type and event type to be intuitively recognizable by providing various editing and display functions according to the user input state in the signal screen in which the time-series information is visualized, as well as enabling continuous tracking and observation of the patient.

In addition, before describing the present invention in detail, it may be noted that the term “user gesture”, appearing below, means “intention” that the user desires to input through an input unit in a terminal provided by the EMR system, and means to contact any one point of a touch screen, namely, to point by the touch.

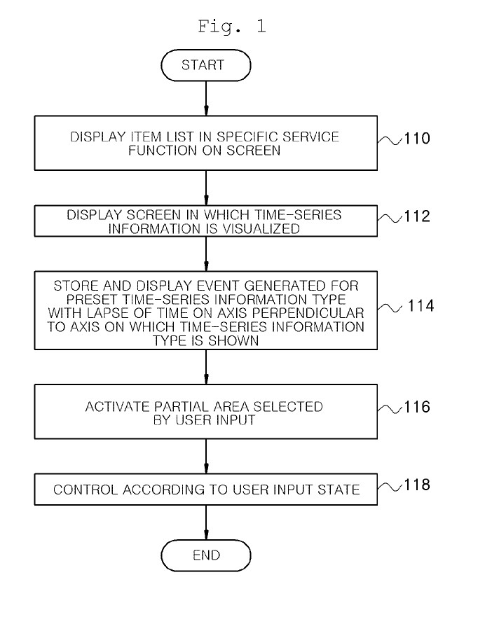

Hereinafter, a detailed description will be provided of a method for displaying data based on an EMR system according to an embodiment of the present invention with reference to FIG. 1.

FIG. 1 is an overall flowchart for a method for displaying data based on an electronic medical record system according to an embodiment of the present invention.

Referring to FIG. 1, in operation 110, an item list in a specific service function is displayed on a screen, wherein the item list has a plurality of partitioned areas and an item corresponding to each of the plurality of partitioned areas is formed.

At this point, each item in the item list displayed on the screen is displayed in each area obtained by partitioning the item list into as many partitions as the number of items included in the specific service function. The item is for displaying or calling a service pertaining to the patient's information among various EMR services provided by the EMR system to which the present invention is applied, and is integrated information on a patient, registered in and managed by the EMR system. In operation 112, in response to a signal for requesting a specific item selected from the displayed item list, a screen is displayed in which time-series information corresponding to the specific item is visualized.

In the screen in which the time-series information is visualized, information on patients generated during a certain period is obtained and arranged in a time series with the lapse of time, and the obtained information is distributed and displayed in a corresponding area on the basis of x- and y-axes in 2-dimensional space.

In operation 114, on the screen in which the time-series information is visualized, an event generated by the preset time-series information type is stored and displayed according to a time change of a predetermined axis, which is perpendicular to the axis on which the time-series information type is shown.

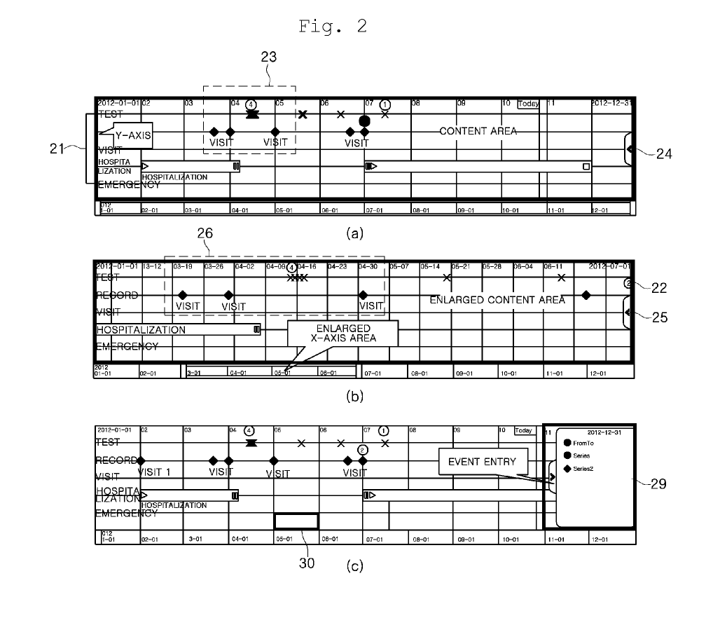

Here, referring to FIG. 2, FIG. 2(a) shows an exemplary screen to which a method for displaying EMR based data is applied according to an embodiment of the present invention. As shown in FIG. 2, the predetermined axis, which is perpendicular to the axis on which the time-series information type is shown, is an axis 22 corresponding to the x-axis direction on the screen in which the time-series information is visualized, and the time is arranged thereon with the lapse of time at which the event for the time-series information occurs in order to enable a time chart to be viewed in a single view. The axis on which the time-series information type is shown is an axis 21, which corresponds to the y-axis direction on the screen in which the time-series information is visualized, and an event entry for the specific item is displayed thereon.

At this point, as shown in FIG. 2, the event includes ‘hospital visit’ displayed in an event area 20, and on the y axis 21, the time-series type (e.g. test, hospital visit, hospitalization, emergency, etc.) for each event is displayed to distinguish the event type.

In operation 116, a partial area, which is selected by a user input in the entire screen area in which the event is displayed, is activated, and in operation 118, the activated partial area is controlled with the user input state.

In detail, the control is to enlarge or reduce the activated partial area by using a user input means, and a partial area 23 selected in FIG. 2(b) is activated, and the activated partial area 23 is enlarged and displayed as shown by the reference numeral 26 in FIG. 2(b). Accordingly, an event area is enlarged and displayed as shown by the reference numeral 27 and the activated partial area 26 has an increase or decrease in an enlargement and reduction ratio according to the user input state.

At this point, when the user input means is a mouse or touch screen, the user input state means the number of times, direction, and moving state of a drag, click, or touch and drag input occurring on the screen via a touch pen or the user's finger.

For example, as shown in FIGS. 2(a) and 2(b), on the x-axis, the time is set on the basis of a first medical examination date to final treatment (reservation) date of a patient, and the time of an enlarged area may be re-set through the enlargement of the partial area according to the user input state between the set time axes.

In addition, a total view or partial view of events shown on a specific time axis is performed according to the enlargement or reduction ratio of the activated partial area. When the user input corresponding to reference numeral 24 shown in FIG. 2(a) occurs, the total view or partial view of events is performed according to the current screen state. The case wherein a number is displayed, like the reference numeral 25 shown in FIG. 2(b), means that the current screen state is the partial view and the number of events that are not displayed by the partial view is displayed by clipping.

This clipping occurs by applying to an area in which the number of generated events is displayed, even in the case where a predetermined event occurs in plurality at a predetermined time.

Furthermore, the selected partial area includes at least one preset edge area (30) in a minimum unit, and the activated partial area is controlled for the units of the edge areas. As shown in FIG. 2(c), the entire screen is configured of a plurality of edge area units on the basis of edge area

In addition, when the user selection is input for a specific event among the displayed events, in the case where a plurality of lower-ranking entries 28 exists in relation to the events, a separate window for displaying the plurality of entries is generated and displayed, like reference numeral 29.

At this point, from a plurality of lower-ranking entries in relation to the events, a user's gesture signal input type (e.g. a user hovers a mouse over, or double-clicks on, an area where an entry is displayed) is detected to display the title related to the lower-ranking entry or display, in a separate area, detailed data corresponding to the title.

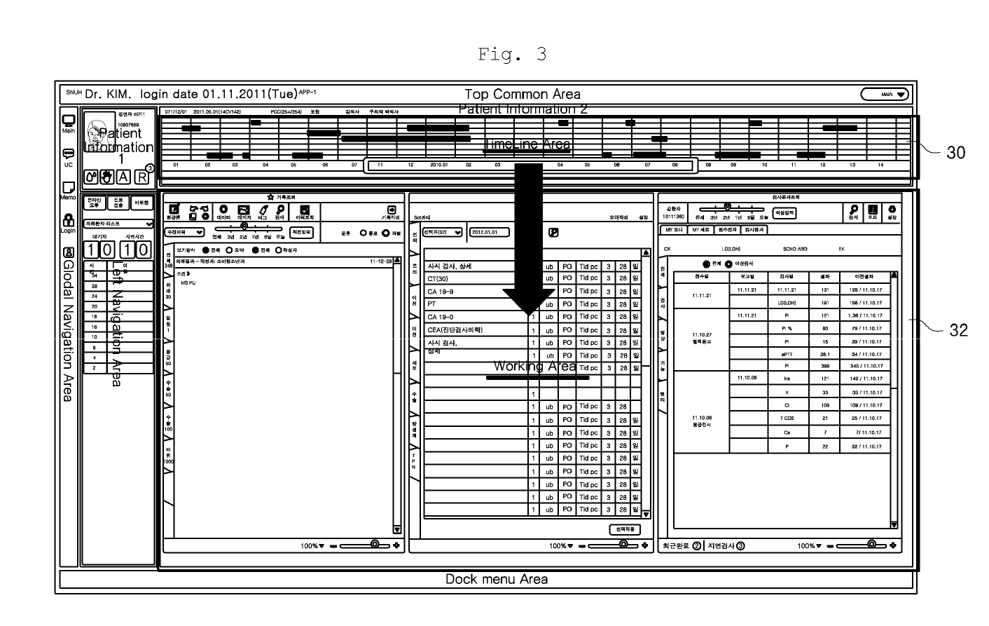

For example, as illustrated in FIG. 3, when the user gesture signal, namely, the double click, occurs on a specific entry among the plurality of lower-ranking entries related to events that are generated on the screen 30, in which the time-series information, which is displayed on the top portion of the entire screen, is visualized, the data for that time is retrieved and displayed on a specific screen in a lower working area 32.

At this point, the user's gesture signal input type is any one pointing operation of a long press touch, tap or flick, click, drag, and double click occurring in the screen area through the user input means.

In addition, the user gesture is a gesture for calling to execute an action related to multiple events through interaction with user-input interrupt in the screen area.

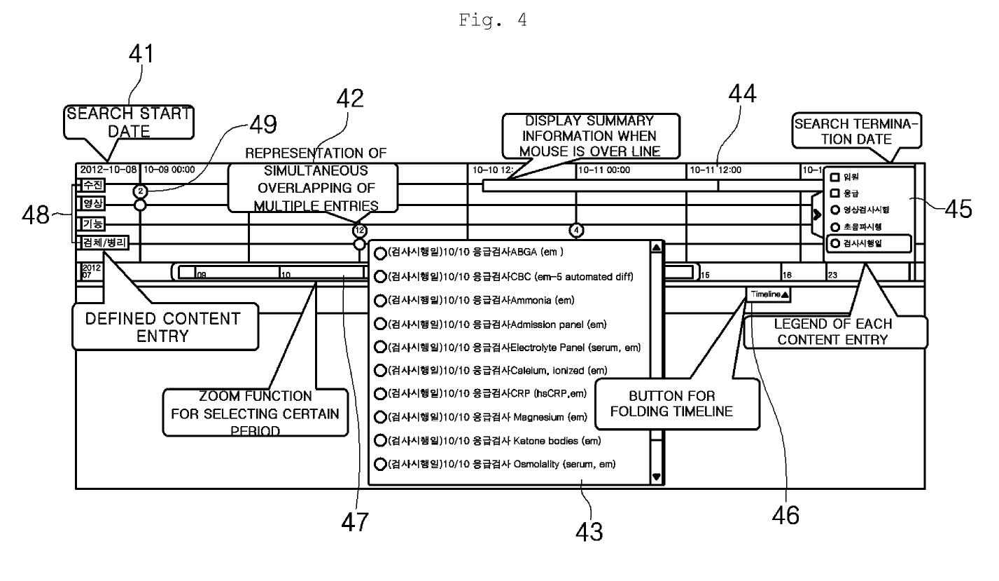

FIG. 4 is an exemplary detailed overall screen to which the method of displaying data based on an electronic medical record system according to an embodiment of the present invention is applied.

Referring to FIG. 4, a preset time-series information type for each edge area is written at reference numeral 48 on the y-axis, which is the left side of a search start date at a reference numeral 41 on the x-axis in the entire screen.

When an event displayed at a predetermined edge area on the basis of the x- and y-axes occurs a plural number of times within a predetermined time, the number of events is displayed in a digit type, like reference numeral 49 or 42. However, in the case where the user gesture signal occurs at reference numeral 42, a separate window is generated to display a lower-ranking entry related to the corresponding event, like reference numeral 43.

In addition, when the user gesture signal is input to a line having a preset length and is displayed on the horizontal axis over the entire screen, for example, whe the mouse is over the screen, events are displayed inn at least two or more edge areas, covered by the line 44, on a separate window 45, which is generated to have a legend of corresponding event entries displayed thereon.

In the entire display screen, a zoom function button 47 for selecting and displaying a certain period on the x-axis and a button 46 for folding the screen, in which the time-series information is visualized, are displayed to enable a setting portion for showing the entirety of the period and only a partial portion of the period to be displayed in a zoom type. For example, when the user drags with the right mouse button pressed down, only the corresponding area is viewed in an enlarged type, is movable to the left and right with the mouse, and is movable by a screen unit in an enlarged state.

Furthermore, a plurality of menus providing services related to events stored and displayed in a specific area are set on the specific area in the entire screen in which the time-series information is visualized. The set menus are lower-ranking entries related to execution commands or events including a plurality of pieces of lower-ranking information, and call a separate window and display a screen corresponding to the execution commands thereon, when the user gesture signal occurs in the execution command area.

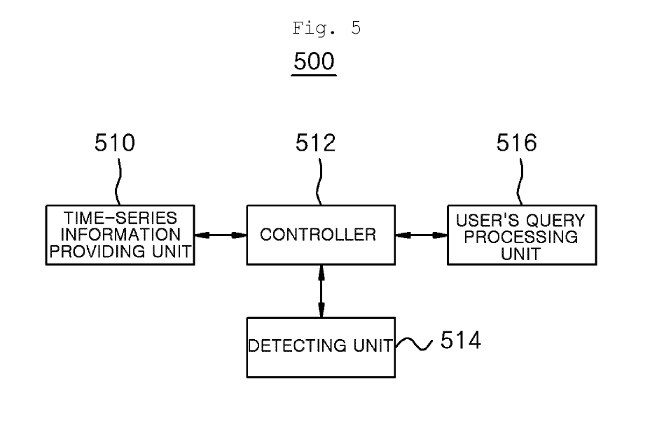

In the foregoing, a method for displaying EMR system based data is described. Hereinafter, a detailed description will be provided of an apparatus for displaying data based on an EMR system according to an embodiment of the present invention with reference to FIG. 5.

FIG. 5 is a detailed block diagram for an apparatus for displaying data based on an electronic medical record system according to an embodiment of the present invention.

Referring to FIG. 5, an apparatus 500, which displays the data of an EMR system to which the present invention is applied, includes a time-series information providing unit 510, a controller 512, a detecting unit 514, and a user's query processing unit 516.

The time-series information providing unit 510 stores time-series information according to a time change for an object, namely, events occurring for each patient, which is provided from a database in the EMR system.

The user's query processing unit 516 receives from a user a desired time-series information type and a state where the time-series information is displayed.

The controller 512 searches the time-series information providing unit 510 for data corresponding to the type and display state of the time-series information input from the user query processing unit 516 and performs control on the found data to be displayed on the current screen, in which the time-series information is visualized.

In addition, the controller 512 displays an item list in a specific service function on a screen, wherein the item list has a plurality of partitioned areas and an item corresponding to each of the plurality of partitioned areas is formed, displays a screen in which the time-series information is visualized in response to a screen request signal for a specific item selected from the displayed list, stores and displays an event occurring for each preset time-series information type on the screen in which the time-series information is visualized with the lapse of time on a predetermined axis, perpendicular to the axis on which the time-series information type is shown, activates a partial area selected by a user's input from among the entire screen area in which the event is displayed, and controls the activated partial area according to a user's input state.

The detecting unit 514 determines the user input state, gesture, an area in which the user input state and gesture signal occur in the entire screen area, and outputs the result of the determination to the controller 514.

Although a method and apparatus for displaying EMR system-based data according to the preferred embodiments of the present invention have been disclosed for illustrative purposes, various modifications, additions and substitutions are possible, without departing from the scope and spirit of the invention. Accordingly, the scope of the present invention should be defined not by the foregoing embodiments, but by the claims and their equivalents.

1. A method for displaying data based on an electronic medical record (EMR) system, the method comprising:
displaying, on a screen, an item list in a specific service function, wherein the item list has a plurality of partitioned areas and an item corresponding to each of the plurality of partitioned areas is formed;
displaying a screen in which time-series information is visualized in response to a request signal for a screen of a specific item selected from the displayed list;
storing and displaying an event occurring for a preset time-series information type on the screen in which the time-series information is visualized with a lapse of time on a predetermined axis, which is perpendicular to an axis on which the time-series information type is shown; and
activating a partial area selected by a user input in an entire screen area in which the event is displayed and controlling the activated partial area according to a user input state.

2. The according to claim 1, wherein the controlling is an enlargement or reduction of the activated partial area using a user input means.

3. The method of claim 1, wherein the predetermined axis perpendicular to the axis on which the time-series information type is displayed is an axis corresponding to an axis of the screen in which the time-series information is visualized, and time is shown on the predetermined axis with the lapse of time according to occurrence of the event for the time-series information.

4. The method of claim 1, wherein the axis on which the time-series information type is shown is an axis corresponding to the y-axis on the screen in which the time-series information is visualized, wherein an event entry for the specific item is displayed thereon.

5. The method of claim 1, wherein the activated partial area has an increase or decrease in an enlargement or reduction ratio according to the user input state.

6. The method of claim 2, wherein a total view or partial view of events displayed on a specific time axis is performed according to an enlargement or reduction ratio of the activated partial area.

7. The method of claim 6, wherein when the partial view is performed or the event occurs in plurality at a predetermined time, a number of events not displayed by the partial view or a number of the generated events is clipped in a predetermined area.

8. The method of claim 1, wherein the selected partial area comprises at least one edge area of a preset minimum unit, and the activated partial area is controlled by the edge area unit.

9. The method of claim 1, further comprising generating a window for displaying a plurality of lower-ranking entries when the plurality of lower-ranking entries related to the event exists at a time of a user's selection input for the displayed event, and displaying the plurality of lower-ranking entries on the window.

10. The method of claim 9, further comprising detecting a user's gesture signal input type in the plurality of lower-ranking entries in relation to the event to display a title related to each of the lower-ranking entries or to display, in a separate area, detailed data corresponding to the title.

11. The method of claim 10, wherein the user's gesture signal input type is any one pointing operation of a long press touch, tap, flick, click, drag, and double click occurring in the screen area through the user input means.

12. The method of claim 1, wherein a plurality of menus is set for providing services related to events displayed in the specific area, and the set menus are execution commands comprising a plurality of pieces of lower-ranking information.

13. The method of claim 10, wherein the user's gesture is a gesture for calling an action related to a plurality of events through an interaction with a user-input interrupt in a screen area and executing the action.

14. The method of claim 1, wherein the user input state is a number of times, direction, and moving state of a drag or click input.

15. An apparatus for displaying data based on an EMR system, the apparatus comprising:
a time-series information providing unit storing time-series information for an object;
a user's query processing unit receiving a desired time-series information type and a display state of the time-series information from a user; and
a controller displaying, on a screen, an item list in a specific service function, wherein the item list has a plurality of partitioned areas and an item corresponding to each of the plurality of partitioned areas is formed; displaying a screen in which time-series information is visualized in response to a request signal for a screen of a specific item selected from the displayed list; storing and displaying an event occurring for a preset time-series information type on the screen in which the time-series information is visualized with a lapse of time on a predetermined axis, which is perpendicular to an axis on which the time-series information type is shown; and activating a partial area selected by a user input in an entire screen area in which the event is displayed and controlling the activated partial area according to a user input state.
